(19) United States
(12) Patent Application Publication
(10) Pub. No.: US 2015/0019811 A1
(43) Pub. Date: Jan. 15, 2015

(54) REMOVABLE STORAGE MEDIA CONTROL APPARATUS FOR PREVENTING DATA LEAKAGE AND METHOD THEREOF

(71) Applicant: ELECTRONICS AND TELECOMMUNICATIONS RESEARCH INSTITUTE, Daejeon (KR)

(72) Inventors: JongJin WON, Daejeon (KR); Eunchan KIM, Daejeon (KR); CheolOh KANG, Daejeon (KR); JeongSeok LIM, Daejeon (KR)

(73) Assignee: ELECTRONICS AND TELECOMMUNICATIONS RESEARCH INSTITUTE, Daejeon (KR)

(21) Appl. No.: 14/258,957

(22) Filed: Apr. 22, 2014

(30) Foreign Application Priority Data
Apr. 11, 2013 (KR) 10-2013-0040088

(51) Int. Cl. G06F 3/06; G06F 21/60

(52) U.S. Cl. CPC G06F 3/0622; G06F 3/0644; G06F 3/0679; G06F 21/602
USPC 711/117

(57) ABSTRACT

A device and method for controlling a removable storage medium to prevent data leakage are provided. The device includes a storage medium determination unit, a storage medium policy acquisition unit, and a storage medium control unit. The storage medium determination unit determines whether a connected storage medium is a removable storage medium. If the storage medium is the removable storage medium, the storage medium policy acquisition unit acquires hierarchical storage medium policies having a hierarchical structure for the storage medium. The storage medium control unit controls the storage medium by switching between a storage medium connection state and a storage medium usage state using the acquired hierarchical storage medium policies.

### CROSS-REFERENCE TO RELATED APPLICATION

This application claims the benefit of Korean Patent Application No. 10-2013-0040088, filed Apr. 11, 2013, which is hereby incorporated by reference herein in its entirety.

### BACKGROUND OF THE INVENTION

1. Technical Field

The present disclosure relates generally to a device and method for controlling a removable storage medium to prevent data leakage and, more particularly, to a device and method for controlling a removable storage medium to prevent data leakage, which are capable of controlling a removable storage medium using storage medium policies.

2. Description of the Related Art

Recently, the usage of removable storage media has been essential to the transfer of data between computers.

Although secure Universal Serial Bus (USB) flash drives are generally used to prevent data leakage via removable storage media, the secure USB flash drives are devices specialized for the encryption of stored data. Secure USB flash drives are disadvantageous in that they are expensive and in that they do not provide a large storage space, unlike external hard disks.

Korean Patent Application Publication No. 10-2010-0040074 discloses a method and server for preventing internal information leakage, and introduces a technology in which, in order to prevent data leakage, data is transferred to a server prior to the writing of the data to an external storage medium, the server inspects the transmitted data for security, and whether to allow the writing is determined based on the results of the inspection.

Furthermore, a technology for preventing illegitimate data leakage from a mobile terminal to an external storage medium is disclosed in the journal of “Korea Institute of Information Security & Cryptology,” Vol. 21, No. 1, pp. 125 to 133, published in February of 2011, and introduces a technology that samples and inspects data to be written to a removable storage medium and determines whether to allow writing based on the results of the inspection.

However, these conventional removable storage medium control technologies disclose only technologies that inspect security target data and determine whether to allow writing to a removable storage medium, but do not disclose a removable storage medium control technology that sequentially controls the connection and usage states of a removable storage medium using storage medium policies having a hierarchical structure and fundamentally blocks the connection of a removable storage medium in which malware has been installed.

Furthermore, the conventional technologies encrypt data upon writing the data to a removable storage medium so that the data can be read only using a dedicated program, but cannot prevent an authorized user from intentionally leaking data.

Accordingly, there is an urgent need for a technology for controlling a removable storage medium, which determines whether a connected storage medium is a removable storage medium, thereby being able to recognize all removable storage media regardless of their connection interface; which sequentially controls the connection and usage states of a removable storage medium using storage medium policies having a hierarchical structure, thereby being able to fundamentally block the connection of a removable storage medium on which malware has been installed; which approves reading from and writing to a removable storage medium using a dedicated program, thereby being able to block the access of malware from a computer to a removable storage medium; and which, when writing is performed to a removable storage medium, encrypts data so that the data can be read only using a dedicated program, thereby being able to block a user's intentional data leakage.

### SUMMARY OF THE INVENTION

At least one embodiment of the present invention is directed to a device and method for controlling a removable storage medium, which determine whether a connected storage medium is a removable storage medium, thereby being able to recognize all removable storage media regardless of their connection interface.

At least one embodiment of the present invention is directed to a device and method for controlling a removable storage medium, which sequentially control the connection and usage states of a removable storage medium using storage medium policies having a hierarchical structure, thereby being able to fundamentally block the connection of a removable storage medium on which malware has been installed.

At least one embodiment of the present invention is directed to a device and method for controlling a removable storage medium, which approve reading from and writing to a removable storage medium using a dedicated program, thereby being able to block the access of malware from a computer to a removable storage medium.

At least one embodiment of the present invention is directed to a device and method for controlling a removable storage medium, which, when writing is performed to a removable storage medium, encrypt data so that the data can be read only using a dedicated program, thereby being able to block a user's intentional data leakage.

In accordance with an aspect of the present invention, there is provided a removable storage media control apparatus for preventing data leakage, including a storage medium determination unit configured to determine whether a connected storage medium is a removable storage medium; a storage medium policy acquisition unit configured to, if the storage medium is the removable storage medium, acquire hierarchical storage medium policies having a hierarchical structure for the storage medium; and a storage medium control unit configured to control the storage medium by switching between a storage medium connection state and a storage medium usage state using the acquired hierarchical storage medium policies.

The hierarchical storage medium policies may include a first storage medium policy adapted to manage the storage medium connection state; and a second storage medium policy adapted to be dependent on the first storage medium policy and to manage the storage medium usage state.

The storage medium control unit may control the storage medium by switching the storage medium connection state to any one of a connection-approved state and a connection-blocked state using the first storage medium policy and by switching the storage medium usage state to any one of a write-approved state, a read-approved state and a use-blocked state using the second storage medium policy.

The storage medium control unit, if the storage medium connection state is the connection-approved state, may determine whether an approaching program that is attempting reading from the storage medium is a previously registered dedicated program; and, if the approaching program is not the dedicated program, may switch the storage medium usage state to the use-blocked state.

The storage medium control unit, if the storage medium usage state is the write-approved state, may allow reading from and writing to the storage medium; and the writing to the storage medium write may be performed to encrypt data and record the data on the storage medium.

The storage medium control unit, if a hash value of the approaching program is identical to a dedicated hash value corresponding to the dedicated program, may determine that the approaching program is the dedicated program.

The storage medium determination unit may acquire a device ID including any one or more of the manufacturer ID, product ID and product version of the storage medium, may acquire an instance ID including the product serial number of the storage medium, and may acquire a storage medium ID generated using the device ID and the instance ID.

The first storage medium policy may include preset approved storage medium IDs; and the storage medium control unit, if the storage medium ID is identical to any one or more of the approved storage medium IDs, may switch the storage medium connection state to the connection-approved state, and, if the storage medium ID is not identical to any one of the approved storage medium IDs, may switch the storage medium connection state to the connection-blocked state.

The storage medium policy acquisition unit may acquire the first and second storage medium policies set differently depending on a plurality of computers.

The device may further include a usage record storage unit configured to store usage records of any one or more of the first storage medium policy, the storage medium ID, the computer ID, the name of the approaching program, the second storage medium policy, and the details and results of one or more tasks of the approaching program.

In accordance with another aspect of the present invention, there is provided a removable storage media control method of preventing data leakage, including determining whether a connected storage medium is a removable storage medium; if the storage medium is the removable storage medium, acquiring hierarchical storage medium policies having a hierarchical structure for the storage medium; and controlling the storage medium by switching between a storage medium connection state and a storage medium usage state using the acquired hierarchical storage medium policies.

The hierarchical storage medium policies may include a first storage medium policy adapted to manage the storage medium connection state; and a second storage medium policy adapted to be dependent on the first storage medium policy and to manage the storage medium usage state.

Controlling the storage medium may include controlling the storage medium by switching the storage medium connection state to any one of a connection-approved state and a connection-blocked state using the first storage medium policy and by switching the storage medium usage state to any one of a write-approved state, a read-approved state and a use-blocked state using the second storage medium policy.

Controlling the storage medium may include, if the storage medium connection state is the connection-approved state, determining whether an approaching program that is attempting reading from the storage medium is a previously registered dedicated program; and, if the approaching program is not the dedicated program, switching the storage medium usage state to the use-blocked state.

Controlling the storage medium may include, if the storage medium usage state is the write-approved state, allowing reading from and writing to the storage medium; and the writing to the storage medium may be performed to encrypt data and record the data on the storage medium.

Controlling the storage medium may include, if a hash value of the approaching program is identical to a dedicated hash value corresponding to the dedicated program, determining that the approaching program is the dedicated program.

Determining whether the connected storage medium is the removable storage medium may include acquiring a device ID including any one or more of the manufacturer ID, product ID and product version of the storage medium, acquiring an instance ID including the product serial number of the storage medium, and acquiring a storage medium ID generated using the device ID and the instance ID.

The first storage medium policy may include preset approved storage medium IDs; and controlling the storage medium may include, if the storage medium ID is identical to any one or more of the approved storage medium IDs, switching the storage medium connection state to the connection-approved state, and, if the storage medium ID is not identical to any one of the approved storage medium IDs, switching the storage medium connection state to the connection-blocked state.

Acquiring the hierarchical storage medium policies may include acquiring the first and second storage medium policies set differently depending on a plurality of computers.

The method may further include storing usage records of any one or more of the first storage medium policy, the storage medium ID, the computer ID, the name of the approaching program, the second storage medium policy, and the details and results of one or more tasks of the approaching program.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of a removable storage media control apparatus for preventing data leakage according to an embodiment of the present invention;

FIG. 2 is a block diagram of an example of the hierarchical structure of hierarchical storage medium policies according to an embodiment of the present invention;

FIG. 3 is an operation flowchart of a removable storage media control method of preventing data leakage according to an embodiment of the present invention; and

FIG. 4 is an operation flowchart of an example of step S330 of controlling a storage medium illustrated in FIG. 3 according an embodiment of the present invention.

### DESCRIPTION OF THE PREFERRED EMBODIMENTS

Embodiments of the present invention are described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clear.

Embodiments of the present invention will be described in detail with reference to the accompanying drawings.

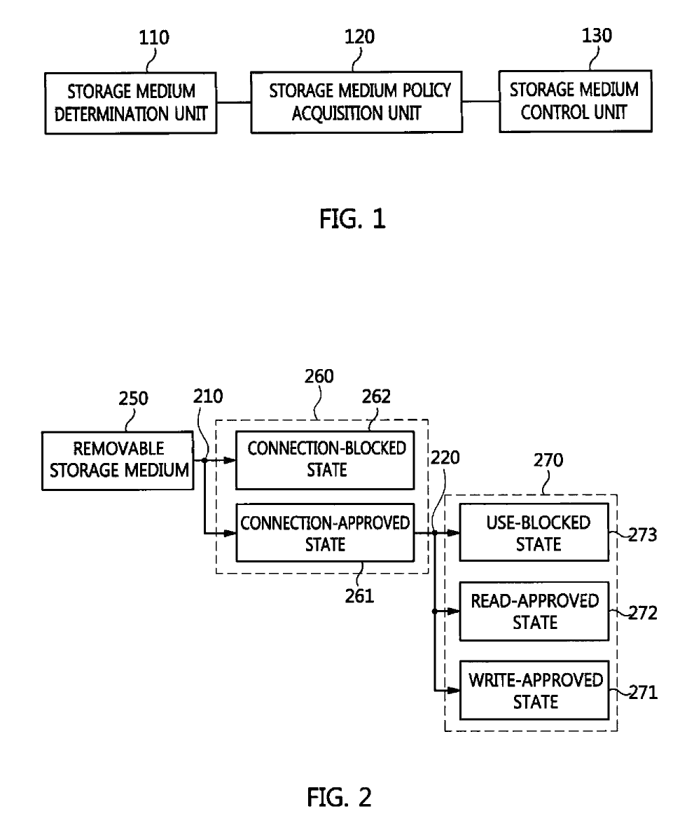

FIG. 1 is a block diagram of a removable storage media control apparatus for preventing data leakage according to an embodiment of the present invention.

Referring to FIG. 1, the removable storage media control apparatus for preventing data leakage according to this embodiment of the present invention includes a storage medium determination unit 110, a storage medium policy acquisition unit 120, and a storage medium control unit 130.

The storage medium determination unit 110 determines whether a connected storage medium is a removable storage medium 250.

In this case, the storage medium determination unit 110 determines whether the storage medium is external memory.

For example, the storage medium determination unit 110 may use a method of, with respect to a device recognized by the Plug and Play (PNP) manager of Windows, determining whether the control code “IOCTL_STORAGE_QUERY_PROPERTY” of the function “DeviceIoControl ( ) is RemovableMedia as a method of determining whether the storage medium is external memory.

In this case, if the storage medium is external memory, the storage medium determination unit 110 determines that the storage medium is a removable storage medium 250.

In this case, if the storage medium is not external memory, the storage medium determination unit 110 determines whether the storage medium is an external hard disk.

For example, the storage medium determination unit 110 may use a method of, with respect to a device recognized by the PNP manager of Windows, determining whether the control code “IOCTL_STORAGE_QUERY_PROPERTY” of the function “DeviceIoControl ( )” is “FILE_DEVICE_DISK” and whether the field value “Characteristics” of the struct “FILE_FS_DEVICE_INFORMATION” of the function “NtQueryVolumeInformationFile” is FILE_REMOVABLE_MEDIA as a method of determining whether the storage medium is an external hard disk.

In this case, if the storage medium is an external hard disk, the storage medium determination unit 110 determines that the storage medium is the removable storage medium 250.

In this case, if the storage medium is not an external hard disk, the storage medium determination unit 110 determines that the storage medium is not the removable storage medium 250.

In this case, the storage medium determination unit 110 may acquire a device ID including any one or more of the manufacturer ID, product ID and product version of the storage medium, may acquire an instance ID including the ID product serial number of the storage medium, and may acquire a storage medium ID generated using the device ID and the instance ID.

If the storage medium is the removable storage medium 250, the storage medium policy acquisition unit 120 acquires hierarchical storage medium policies for the storage medium.

In this case, the hierarchical storage medium policies may include a first storage medium policy 210 adapted to manage a storage medium connection state 260, and a second storage medium policy 220 adapted to be dependent upon the first storage medium policy 210 and to manage a storage medium usage state 270.

In this case, the first storage medium policy 210 may be adapted to include preset approved storage medium IDs, to transfer the approved storage medium IDs to the storage medium control unit 130, and to switch the storage medium connection state 260 to a connection-approved state 261 if the storage medium ID is the same as any one more of the approved storage medium IDs and switch the storage medium connection state 260 to a connection-blocked state 262 if the storage medium ID is not the same as any one of the approved storage medium IDs.

In this case, the first storage medium policy 210 may be adapted to include preset blocked storage medium IDs, to transfer the blocked storage medium IDs to the storage medium control unit 130, and to switch the storage medium connection state 260 to the connection-blocked state 262 if the storage medium ID is the same as any one or more of the blocked storage medium IDs.

In this case, the blocked storage medium IDs may be blocked storage medium IDs that have been set because storage media correspond to any one or more of loss and damage.

In this case, the second storage medium policy 220 may be adapted to include preset writing computer IDs, to transfer the writing computer IDs to the storage medium control unit 130, and to switch the storage medium usage state 270 to a write-approved state 271 if the computer ID is the same as any one or more of the writing computer IDs.

In this case, the second storage medium policy 220 may be adapted to include preset reading computer IDs, to transfer the reading computer IDs to the storage medium control unit 130, and to switch the storage medium usage state 270 to a read-approved state 272 if the computer ID is the same as any one or more of the reading computer IDs and switch the storage medium usage state 270 to a use-blocked state 273 if the computer ID is not the same as any one of the reading computer IDs.

In this case, the storage medium policy acquisition unit 120 may acquire the hierarchical storage medium policies from a policy management server.

In this case, the storage medium policy acquisition unit 120 may transmit the computer ID to the policy management server, and may acquire the hierarchical storage medium policies corresponding to the computer ID.

In this case, the storage medium policy acquisition unit 120 may acquire the first and second storage medium policies 210 and 220 set differently depending on a plurality of computers.

In this case, the storage medium policy acquisition unit 120 may acquire the hierarchical storage medium policies from the policy management server using an authentication code authentication method.

In this case, the computer ID may be a computer ID generated by combining any one or more of a computer Internet Protocol (IP) address, an Ethernet hardware address, an Operation System (OS) login ID, and a user name.

The storage medium control unit 130 controls the storage medium by changing the storage medium connection state 260 and the storage medium usage state 270 using the acquired hierarchical storage medium policies.

In this case, the storage medium control unit 130 may control the storage medium by switching the storage medium connection state 260 to any one of the connection-approved state 261 and the connection-blocked state 262 using the first storage medium policy 210 and switching the storage medium usage state 270 to any one of the write-approved state 271, the read-approved state 272 and the use-blocked state 273 using the second storage medium policy 220.

In this case, the first storage medium policy 210 may include preset approved storage medium IDs, and the storage medium control unit 130 may switch the storage medium connection state 260 to the connection-approved state 261 if the storage medium ID is the same as any one or more of the approved storage medium IDs and switch the storage medium connection state 260 to the connection-blocked state 262 if the storage medium ID is not the same as any one of the approved storage medium IDs.

In this case, if the storage medium connection state 260 is the connection-approved state 261, the storage medium control unit 130 may determine whether an approaching program that is attempting reading from the storage medium is a previously registered dedicated program, and may switch the storage medium usage state 270 to the use-blocked state 273 if the approaching program is not the dedicated program.

In this case, if the storage medium usage state 270 is the write-approved state 271, the storage medium control unit 130 may allow reading from and writing to the storage medium, and the writing to the storage medium may be performed to encrypt data and record it on the storage medium.

In this case, the storage medium control unit 130 may determine that the approaching program is the dedicated program if the hash value of the approaching program is the same as a dedicated hash value corresponding to the dedicated program.

In this case, the storage medium control unit 130 may switch the storage medium connection state 260 to the connection-blocked state 262 if the storage medium policy acquisition unit 120 does not acquire the hierarchical storage medium policies.

Although not illustrated in FIG. 1, a removable storage media control apparatus for preventing data leakage according to an embodiment of the present invention may include a usage record storage unit that stores usage records of any one or more of the first storage medium policy 210, the storage medium IDs, the computer IDs, the name of the approaching program, the second storage medium policy 220, and the details and results of the one or more tasks of the approaching program.

FIG. 2 is a block diagram of an example of the hierarchical structure of hierarchical storage medium policies according to an embodiment of the present invention.

Referring to FIG. 2, the hierarchical structure of hierarchical storage medium policies according to an embodiment of the present invention includes the first storage medium policy 210 and the second storage medium policy 220 dependent on the first storage medium policy 210.

For example, the first storage medium policy 210 manages the storage medium connection state 260.

In this case, the first storage medium policy 210 may be adapted to include preset approved storage medium IDs, to transfer the approved storage medium IDs to the storage medium control unit 130, and to switch the storage medium connection state 260 to the connection-approved state 261 if the storage medium ID is the same as any one or more of the approved storage medium IDs and switch the storage medium connection state 260 to the connection-blocked state 262 if the storage medium ID is not the same as any one of the approved storage medium TDs.

In this case, the first storage medium policy 210 may be adapted to include preset blocked storage medium IDs, to transfer the blocked storage medium IDs to the storage medium control unit 130, and to switch the storage medium connection state 260 to the connection-blocked state 262 if the storage medium ID is the same as any one or more of the blocked storage medium IDs.

In this case, the blocked storage medium IDs may be blocked storage medium IDs that have been set because storage media correspond to any one or more of loss and damage.

For example, the second storage medium policy 220 may manage the storage medium usage state 270.

In this case, the second storage medium policy 220 may be adapted to include preset writing computer IDs, to transfer the writing computer IDs to the storage medium control unit 130, and to switch the storage medium usage state 270 to a write-approved state 271 if the computer ID is the same as any one or more of the writing computer IDs.

In this case, the second storage medium policy 220 may be adapted to include preset reading computer IDs, to transfer the reading computer IDs to the storage medium control unit 130, and to switch the storage medium usage state 270 to the read-approved state 272 if the computer ID is the same as any one or more of the reading computer IDs and switch the storage medium usage state 270 to the use-blocked state 273 if the computer ID is not the same as any one of the reading computer IDs.

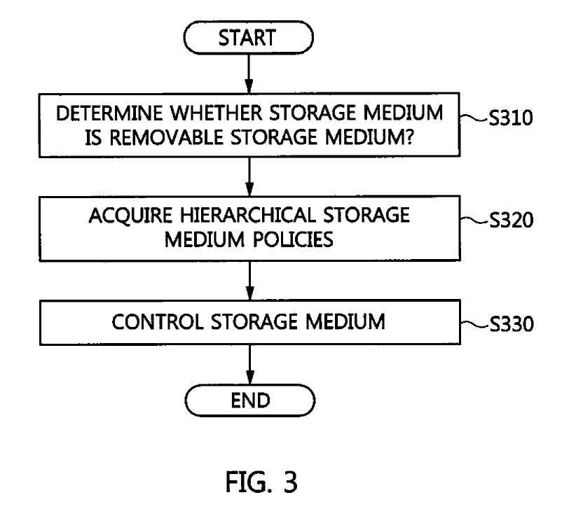

FIG. 3 is an operation flowchart of a removable storage media control method of preventing data leakage according to an embodiment of the present invention.

Referring to FIG. 3, in the removable storage media control method of preventing data leakage, it is determined whether a connected storage medium is the removable storage medium 250 at step 310.

In this case, at step 310, it is determined whether the storage medium is external memory.

For example, at step 310, a method of, with respect to a device recognized by the PNP manager of Windows, determining whether the control code “IOCTL_STORAGE_QUERY_PROPERTY” of the function “DeviceIoControl ( ) is RemovableMedia may be used as a method of determining whether the storage medium is external memory.

In this case, at step 310, if the storage medium is external memory, it is determined that the storage medium is a removable storage medium 250.

In this case, at step 310, if the storage medium is not external memory, it is determined whether the storage medium is an external hard disk.

For example, at step 310, a method of, with respect to a device recognized by the PNP manager of Windows, determining whether the control code “IOCTL_STORAGE_QUERY_PROPERTY” of the function “DeviceIoControl ( )” is “FILE_DEVICE_DISK” and whether the field value “Characteristics” of the struct “FILE_FS_DEVICE_INFORMATION” of the function “NtQueryVolumeInformationFile” is FILE_REMOVABLE_MEDIA may be used as a method of determining whether the storage medium is an external hard disk.

In this case, at step 310, if the storage medium is an external hard disk, it is determined that the storage medium is the removable storage medium 250.

In this case, at step 310, if the storage medium is not an external hard disk, it is determined that the storage medium is not the removable storage medium 250.

In this case, at step 310, a device ID including any one or more of the manufacturer ID, product ID and product version of the storage medium may be acquired, an instance ID including the ID product serial number of the storage medium may be acquired, and a storage medium ID generated using the device ID and the instance ID may be acquired.

In the removable storage media control method of preventing data leakage, if the storage medium is the removable storage medium 250, hierarchical storage medium policies for the storage medium is acquired at step S320.

In this case, the hierarchical storage medium policies may include the first storage medium policy 210 adapted to manage the storage medium connection state 260, and a second storage medium policy 220 adapted to be dependent upon the first storage medium policy 210 and to manage a storage medium usage state 270.

In this case, the first storage medium policy 210 may be adapted to include preset approved storage medium IDs, to transfer the approved storage medium IDs to step S330, and to switch the storage medium connection state 260 to the connection-approved state 261 if the storage medium ID is the same as any one more of the approved storage medium IDs and switch the storage medium connection state 260 to the connection-blocked state 262 if the storage medium ID is not the same as any one of the approved storage medium IDs.

In this case, the first storage medium policy 210 may be adapted to include preset blocked storage medium IDs, to transfer the blocked storage medium IDs to step S330, and to switch the storage medium connection state 260 to the connection-blocked state 262 if the storage medium ID is the same as any one or more of the blocked storage medium IDs.

In this case, the blocked storage medium IDs may be blocked storage medium IDs that have been set because storage media correspond to any one or more of loss and damage.

In this case, the second storage medium policy 220 may be adapted to include preset writing computer IDs, to transfer the writing computer IDs to step S330, and to switch the storage medium usage state 270 to the write-approved state 271 if the computer ID is the same as any one or more of the writing computer IDs.

In this case, the second storage medium policy 220 may be adapted to include preset reading computer IDs, to transfer the reading computer IDs to step S330, and to switch the storage medium usage state 270 to the read-approved state 272 if the computer ID is the same as any one or more of the reading computer IDs and switch the storage medium usage state 270 to the use-blocked state 273 if the computer ID is not the same as any one of the reading computer IDs.

In this case, at step 320, the hierarchical storage medium policies may be acquired from a policy management server.

In this case, at step 320, the computer ID may be transmitted to the policy management server, and the hierarchical storage medium policies corresponding to the computer ID may be acquired.

In this case, at step 320, the first and second storage medium policies 210 and 220 set differently depending on a plurality of computers may be acquired.

In this case, at step 320, the hierarchical storage medium policies may be acquired from the policy management server using an authentication code authentication method.

In this case, the computer ID may be a computer ID generated by combining any one or more of a computer IP address, an Ethernet hardware address, an OS login ID, and a user name.

In the removable storage media control method of preventing data leakage, the storage medium is controlled by changing the storage medium connection state 260 and the storage medium usage state 270 using the acquired hierarchical storage medium policies at step S330.

In this case, at step S330, the storage medium may be controlled by switching the storage medium connection state 260 to any one of the connection-approved state 261 and the connection-blocked state 262 using the first storage medium policy 210 and switching the storage medium usage state 270 to any one of the write-approved state 271, the read-approved state 272 and the use-blocked state 273 using the second storage medium policy 220.

In this case, the first storage medium policy 210 may include preset approved storage medium IDs. At step S330, the storage medium connection state 260 may be switched to the connection-approved state 261 if the storage medium ID is the same as any one or more of the approved storage medium IDs, and the storage medium connection state 260 may be switched to the connection-blocked state 262 if the storage medium ID is not the same as any one of the approved storage medium IDs.

In this case, at step S330, if the storage medium connection state 260 is the connection-approved state 261, it may be determined whether an approaching program that is attempting reading from the storage medium is a previously registered dedicated program, and the storage medium usage state 270 may be switched to the use-blocked state 273 if the approaching program is not the dedicated program.

In this case, at step S330, if the storage medium usage state 270 is the write-approved state 271, reading from and writing to the storage medium may be allowed, and the writing to the storage medium may be performed to encrypt data and record it on the storage medium.

In this case, at step S330, it may be determined that the approaching program is the dedicated program if the hash value of the approaching program is the same as a dedicated hash value corresponding to the dedicated program.

In this case, at step S330, the storage medium connection state 260 may be switched to the connection-blocked state 262 if the hierarchical storage medium policies have not been acquired at step S320.

Although not illustrated in FIG. 3, a removable storage media control method of preventing data leakage according to an embodiment of the present invention may include the step of storing usage records of any one or more of the first storage medium policy 210, the storage medium IDs, the computer IDs, the name of the approaching program, the second storage medium policy 220, and the details and results of the tasks of the approaching program.

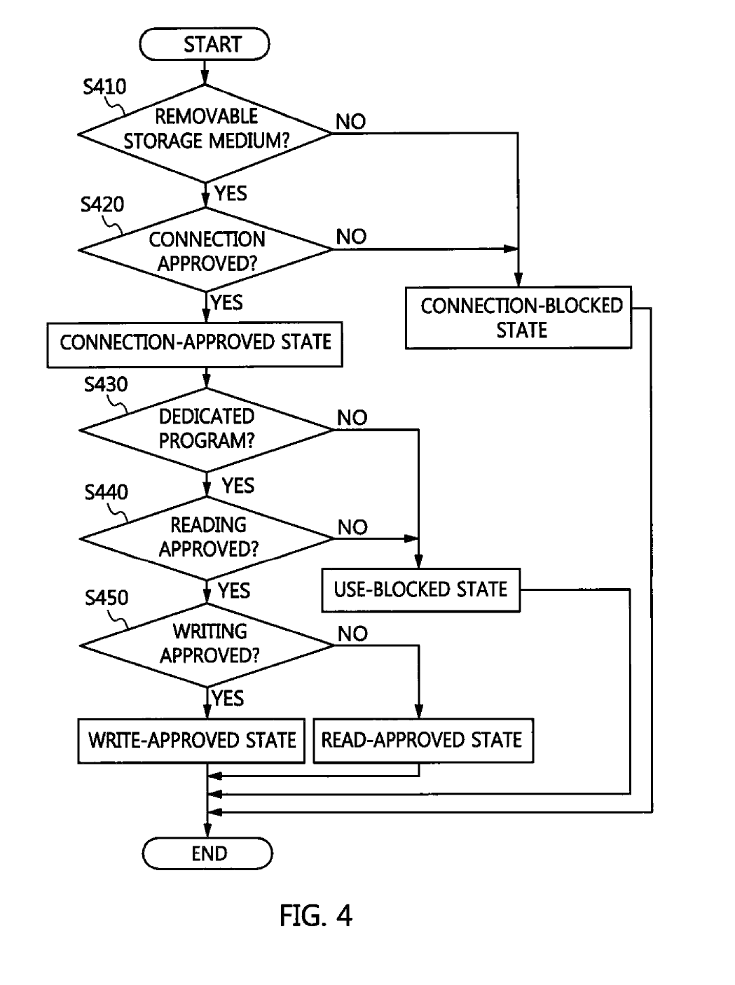

FIG. 4 is an operation flowchart of an example of step S330 of controlling a storage medium illustrated in FIG. 3 according an embodiment of the present invention.

Referring to FIG. 4 in conjunction with FIG. 3, in step S330 of controlling a storage medium illustrated in FIG. 3, the storage medium connection state 260 is switched to the connection-blocked state 262 if it is determined at step S310 that the storage medium is not the removable storage medium 250 and the process proceeds to step S420 if it is determined at step S310 that the storage medium is the removable storage medium 250, at step S410.

Furthermore, in step S330 of controlling a storage medium illustrated in FIG. 3, using the first storage medium policy 210, the storage medium connection state 260 is switched to the connection-blocked state 262 if the storage medium ID is not any one of the approved storage medium IDs, and the storage medium connection state 260 is switched to the connection-approved state 261 if the storage medium ID is the same as any one or more of the approved storage medium IDs, at step S420.

Furthermore, in step S330 of controlling a storage medium illustrated in FIG. 3, it is determined whether an approaching program that is attempting reading from the storage medium is a previously registered dedicated program, the storage medium usage state 270 is switched to the use-blocked state 273 if the approaching program is not the dedicated program, and the process proceeds to step S440 if the approaching program is the dedicated program, at step S430.

Furthermore, in step S330 of controlling a storage medium illustrated in FIG. 3, using the second storage medium policy 220, the storage medium usage state 270 is switched to the use-blocked state 273 if the computer ID is not the same as any one of the reading computer IDs, and the process proceeds to step S450 if the computer ID is the same as any one or more of the reading computer IDs, at step S440.

Furthermore, in step S330 of controlling a storage medium illustrated in FIG. 3, using the second storage medium policy 220, the storage medium usage state 270 is switched to the read-approved state 272 if the computer ID is not the same as any one of the reading computer IDs, and the storage medium usage state 270 may be switched to the write-approved state 271 if the computer ID is the same as any one or more of the writing computer IDs, at step 450.

A device and method for controlling a removable storage medium according to at least one embodiment of the present invention have the advantage of determining whether a connected storage medium is a removable storage medium, thereby being able to recognize all removable storage media regardless of their connection interface.

A device and method for controlling a removable storage medium according to at least one embodiment of the present invention have the advantage of sequentially controlling the connection and usage states of a removable storage medium using storage medium policies having a hierarchical structure, thereby being able to fundamentally block the connection of a removable storage medium on which malware has been installed.

A device and method for controlling a removable storage medium according to at least one embodiment of the present invention have the advantage of approving reading from and writing to a removable storage medium using a dedicated program, thereby being able to block the access of malware from a computer to a removable storage medium.

A device and method for controlling a removable storage medium according to at least one embodiment of the present invention have the advantage of, when writing is performed to a removable storage medium, encrypting data so that the data can be read only using a dedicated program, thereby being able to block a user's intentional data leakage.

Although the preferred embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. A removable storage media control apparatus for preventing data leakage, comprising:
a storage medium determination unit configured to determine whether a connected storage medium is a removable storage medium;
a storage medium policy acquisition unit configured to, if the storage medium is the removable storage medium, acquire hierarchical storage medium policies having a hierarchical structure for the storage medium; and
a storage medium control unit configured to control the storage medium by switching a storage medium connection state and a storage medium usage state using the acquired hierarchical storage medium policies,
wherein the hierarchical storage medium policies comprise:
a first storage medium policy for switching the storage medium connection state to any one of a connection-approved state and a connection-blocked state depending on whether ID of the storage medium corresponds to any one of approved storage medium IDs and blocked storage medium IDs; and
a second storage medium policy for switching the storage medium usage state to any one of a write-approved state, a read-approved state and a use-blocked state depending on whether ID of a computer that is attempting approaching to storage medium corresponds to any one of reading computer IDs and writing computer IDs if the storage medium connection state is the connection-approved state.

2. The device of claim 1, wherein:
the storage medium control unit, if the storage medium usage state is the write-approved state, allows reading from and writing to the storage medium; and
the writing to the storage medium write is performed to encrypt data and record the data on the storage medium.

3. The device of claim 1, wherein the storage medium control unit, if a hash value of the approaching program is identical to a dedicated hash value corresponding to the dedicated program, determines that the approaching program is the dedicated program.

4. The device of claim 1, wherein the storage medium determination unit acquires a device ID including any one or more of a manufacturer ID, product ID and product version of the storage medium, acquires an instance ID including a product serial number of the storage medium, and acquires a storage medium ID generated using the device ID and the instance ID.

5. The device of claim 4, wherein the storage medium control unit, if the storage medium ID is identical to any one or more of the approved storage medium IDs, switches the storage medium connection state to the connection-approved state, and, if the storage medium ID is not identical to any one of the approved storage medium IDs, switches the storage medium connection state to the connection-blocked state.

6. The device of claim 1, wherein the storage medium policy acquisition unit acquires the first and second storage medium policies set differently depending on a plurality of computers.

7. The device of claim 4, further comprising a usage record storage unit configured to store usage records of any one or more of the first storage medium policy, the storage medium ID, the computer ID, a name of the approaching program, the second storage medium policy, and details and results of one or more tasks of the approaching program.

8. A removable storage media control method of preventing data leakage, comprising:
determining whether a connected storage medium is a removable storage medium;
if the storage medium is the removable storage medium, acquiring hierarchical storage medium policies having a hierarchical structure for the storage medium; and
controlling the storage medium by switching between a storage medium connection state and a storage medium usage state using the acquired hierarchical storage medium policies,
wherein the hierarchical storage medium policies comprise:
a first storage medium policy for switching the storage medium connection state to any one of a connection-approved state and a connection-blocked state depending on whether ID of the storage medium corresponds to any one of approved storage medium IDs and blocked storage medium IDs; and
a second storage medium policy for switching the storage medium usage state to any one of a write-approved state, a read-approved state and a use-blocked state depending on whether ID of a computer that is attempting approaching to storage medium corresponds to any one of reading computer IDs and writing computer IDs if the storage medium connection state is the connection-approved state.

9. The method of claim 8, wherein controlling the storage medium comprises, if the storage medium usage state is the write-approved state, allowing reading from and writing to the storage medium; and
the writing to the storage medium is performed to encrypt data and record the data on the storage medium.

10. The method of claim 8, wherein controlling the storage medium comprises, if a hash value of the approaching program is identical to a dedicated hash value corresponding to the dedicated program, determining that the approaching program is the dedicated program.

11. The method of claim 8, wherein determining whether the connected storage medium is the removable storage medium comprises acquiring a device ID including any one or more of a manufacturer ID, product ID and product version of the storage medium, acquiring an instance ID including a product serial number of the storage medium, and acquiring a storage medium ID generated using the device ID and the instance ID.

12. The method of claim 11, wherein:
controlling the storage medium comprises, if the storage medium ID is identical to any one or more of the approved storage medium IDs, switching the storage medium connection state to the connection-approved state, and, if the storage medium ID is not identical to any one of the approved storage medium IDs, switching the storage medium connection state to the connection-blocked state.

13. The method of claim 8, wherein acquiring the hierarchical storage medium policies comprises acquiring the first and second storage medium policies set differently depending on a plurality of computers.

14. The method of claim 11, further comprising storing usage records of any one or more of the first storage medium policy, the storage medium ID, the computer ID, a name of the approaching program, the second storage medium policy, and details and results of one or more tasks of the approaching program.
